(19) United States
(12) Patent Application Publication
(10) Pub. No.: US 2007/0259265 A1
(43) Pub. Date: Nov. 8, 2007

(54) SECONDARY ELECTROCHEMICAL CELL HAVING A NOVEL ELECTRODE ACTIVE MATERIAL

(76) Inventors: M. Yazid Saidi, Henderson, NV (US); Haitao Huang, Henderson, NV (US)

Correspondence Address: VALENCE TECHNOLOGY, INC., 1889 E. MAULE AVENUE, SUITE A, LAS VEGAS, NV, 89119, US

(21) Appl. No.: 11/742,059

(22) Filed: Apr. 30, 2007

Related U.S. Application Data
(60) Provisional application No. 60/746,189, filed on May 2, 2006.

(51) Int. Cl. H01M 4/48; H01M 4/58; H01M 4/50

(52) U.S. Cl. 429/231.1; 429/231.9; 429/231.4; 429/231.2; 429/231.5; 429/224

(57) ABSTRACT

The invention provides a novel polyanion-based electrode active material for use in a secondary or rechargeable electrochemical cell having a first electrode, a second electrode and an electrolyte.

This Application claims the benefit of Provisional Application Ser. No. 60/746,189 filed May 2, 2006.

### FIELD OF THE INVENTION

This invention relates to a novel electrode active material intended for use in a secondary or rechargeable electrochemical cell.

### BACKGROUND OF THE INVENTION

A battery consists of one or more electrochemical cells, wherein each cell typically includes a positive electrode, a negative electrode, and an electrolyte or other material for facilitating movement of ionic charge carriers between the negative electrode and positive electrode. As the cell is charged, cations migrate from the positive electrode to the electrolyte and, concurrently, from the electrolyte to the negative electrode. During discharge, cations migrate from the negative electrode to the electrolyte and, concurrently, from the electrolyte to the positive electrode.

Such batteries generally include an electrochemically active material having a crystal lattice structure or framework from which ions can be extracted and subsequently reinserted, and/or permit ions to be inserted or intercalated and subsequently extracted.

### SUMMARY OF THE INVENTION

The present invention provides a novel electrode active material, wherein in its nascent or as-prepared state, the active material is represented by the general formula:

AₐMI_{b}MII_{c}O₄,

wherein:
(i) A is selected from the group consisting of elements from Group I of the Periodic Table, and mixtures thereof, wherein 0<a<8;
(ii) MI is selected from the group consisting of divalent cations, and mixtures thereof, wherein 0<b<4; and
(iii) MII is selected from the group consisting of tetravalent cations, and mixtures thereof, wherein 0<c<2;
(iv) wherein at least one of the cations comprising MI and MII is redox active; and
(v) wherein A, MI, MII, a, b and c are selected so as to maintain electroneutrality of the electrode active material in its nascent state.

The present invention also provides a secondary electrochemical cell or battery containing the novel electrode active material of the present invention.

### BRIEF DESCRIPTION OF THE DRAWINGS

FIG. 1 is a schematic cross-sectional diagram illustrating the structure of an embodiment of an electrochemical cell of the present invention.

FIG. 2 is a schematic cross-sectional diagram illustrating the structure of another embodiment of an electrochemical cell of the present invention.

FIG. 3 is an X-ray powder diffraction spectrum for LiNi_{0.5}Ti_{1.5}O₄.

FIG. 4 is a plot of cathode specific capacity vs. cell voltage for a Li/1M LiPF₆(EC/DEC)/LiNi_{0.5}Ti_{1.5}O₄ cell.

### DETAILED DESCRIPTION OF THE PREFERRED EMBODIMENTS

It has been found that the novel electrode active material of this invention afford benefits over such materials among those known in the art. Such benefits include, without limitation, one or more of increased operating voltage, increased capacity, enhanced cycling capability, enhanced reversibility, enhanced ionic conductivity, enhanced electrical conductivity, and reduced costs. Specific benefits and embodiments of the present invention are apparent from the detailed description set forth herein below. It should be understood, however, that the detailed description and specific examples, while indicating embodiments among those preferred, are intended for purposes of illustration only and are not intended to limit the scope of the invention.

The present invention provides an electrode active material, wherein in its nascent or as-prepared state, the active material is represented by the general formula (I):

AₐMI_{b}MII_{c}O₄ (I)

The composition of moieties A, MI and MII, as defined herein, as well as the stoichiometric, values of the elements of the active material, are selected so as to maintain electroneutrality of the electrode active material in its nascent or as-synthesized state, and specifically to satisfy the formula (II)

a+b(V^{MI})+c(V^{MI})=8, (II)

wherein V^{MI} is the sum of the oxidation state(s) of the element(s) comprising moiety MI, and V^{MII} is the sum of the oxidation state(s) of the element(s) comprising moiety MII. The stoichiometric values of one or more elements of the composition may take on non-integer values.

For all embodiments described herein, A is selected from the group consisting of elements from Group I of the Periodic Table, and mixtures thereof (e.g. Aₐ=A_{a-a′}A′_{a′}, wherein A and A′ are each selected from the group consisting of elements from Group I of the Periodic Table and are different from one another, and a′<a). As referred to herein, “Group” refers to the Group numbers (i.e., columns) of the Periodic Table as defined in the current IUPAC Periodic Table. (See, e.g., U.S. Pat. No. 6,136,472 to Barker et al., incorporated by reference herein.) In addition, the recitation of a genus of elements, materials or other components, from which an individual component or mixture of components can be selected, is intended to include all possible sub-generic combinations of the listed components, and mixtures thereof. Also, “include,” and its variants, is intended to be non-limiting, such that recitation of items in a list is not to the exclusion of other like items that may also be useful in the materials, compositions, devices, and methods of this invention.

In one subembodiment, A is selected from the group consisting of Li (Lithium), Na (Sodium), K (Potassium), and mixtures thereof. In another subembodiment, A selected from the group consisting of Na, and a mixture of Na with K, and a mixture of Na with Li. In one subembodiment, A is Li.

A sufficient quantity (a) of moiety A should be present so as to allow all of the “redox active” elements of the electrode active material (as defined herein below) to undergo oxidation/reduction. In one embodiment, 0≦a<4. In another embodiment, 0<a<4. In another embodiment, 0<a≦2. In one particular embodiment, a>2b. In another particular embodiment, a=2b. Unless otherwise specified, a variable described herein algebraically as equal to (“=”), less than or equal to (“≧”), or greater than or equal to (“≧”) a number is intended to subsume values or ranges of values about equal or functionally equivalent to the number.

Removal of an amount (a) of moiety A from the electrode active material is accompanied by a change in oxidation state of at least one of the “redox active” elements in the active material, as defined herein below. The amount of redox active material available for oxidation/reduction in the active material determines the amount (a) of moiety A that may be removed. Such concepts are, in general application, known in the art, e.g., as disclosed in U.S. Pat. No. 4,477,541 to Fraioli and U.S. Pat. No. 6,136,472 to Barker, et al., both of which are incorporated by reference herein.

In general, the amount (a) of moiety A in the active material varies during charge/discharge. Where the active materials of the present invention are synthesized for use in preparing an alkali metal-ion battery in a discharged state, such active materials are characterized by a relatively high value of “a”, with a correspondingly low oxidation state of the redox active components of the active material. As the electrochemical cell is charged from its initial uncharged state, an amount (a″) of moiety A is removed from the active material as described above. The resulting structure, containing less amount of moiety A (i.e., a-a″) than in the nascent or as-prepared state, and at least one of the redox active components having a higher oxidation state than in the as-prepared state, while essentially maintaining the original stoichiometric values of the remaining components (e.g. MI and MII). The active materials of this invention include such materials in their nascent state (i.e., as manufactured prior to inclusion in an electrode) and materials formed during operation of the battery (i.e., by insertion or removal of A).

For all embodiments described herein, at least one of moieties MI and MII includes at least one redox active element. As used herein, the term “redox active element” includes those elements characterized as being capable of undergoing oxidation/reduction to another oxidation state when the electrochemical cell is operating under normal operating conditions. As used herein, the term “normal operating conditions” refers to the intended voltage at which the cell is charged, which, in turn, depends on the materials used to construct the cell. As referred to herein, “non-redox active elements” include elements that are capable of forming stable active materials, and do not undergo oxidation/reduction when the electrochemical cell is operating under normal operating conditions. As used herein, the term “normal operating conditions” refers to the intended voltage at which the cell is charged, which, in turn, depends on the materials used to construct the cell.

For all embodiments described herein, when the electrode active material is in its nascent or as-synthesized state (prior to undergoing oxidation/reduction in an electrochemical cell), V^{MI}=2+ and V^{MII}=4+, wherein V^{MI} is the sum of the oxidation state(s) of the element(s) comprising moiety MI, and V^{MII} is the sum of the oxidation state(s) of the element(s) comprising moiety MII.

For all embodiments described herein, MI is selected from the group consisting of divalent cations, and mixtures thereof. In one embodiment, MI is a divalent transition metal cation selected from the group consisting of elements from Groups 4 through 11 of the Period Table. In one subembodiment, MI is selected from the group consisting of Fe²⁺, CO²⁺, Ni²⁺ and mixtures thereof. In another subembodiment, MI is selected from the group consisting of Fe²⁺, CO²⁺ and Ni²⁺. In yet another subembodiment, MI is Ni²⁺.

For all embodiments described herein, MII is selected from the group consisting of tetravalent cations, and mixtures thereof. By substituting MI with a stoichiometric amount of a tetravalent (4+) cation(s), MI takes a 2+ oxidation state in order to maintain electroneutrality of the nascent electrode active material. In one embodiment, 0<b<4. In another embodiment, 0<b≦2.

Elements useful herein with respect to moiety MII include elements from Groups 4 through 11 of the Periodic Table, as well as select non-transition metals, including, without limitation, Ti⁴⁺, V⁴⁺, Mn⁴⁺, Zr⁴⁺, Ru⁴⁺, Pd⁴⁺, Sn⁴⁺, Mo⁴⁺, Pt⁴⁺, Si⁴⁺, C⁴⁺, and mixtures thereof. In one subembodiment, moiety M is selected from the group consisting of Ti⁴⁺, Zr⁴⁺, and Si⁴⁺.

In one embodiment, 0<b<4. In another embodiment, 1≦b≦2. In another embodiment, 0<b≦1.

In one particular embodiment of the present invention, the electrode active material, in its nascent or as-prepared state, is represented by the general formula (III):

AₐNi_{b}MII_{c}O₄, (III)

wherein:
(i) 0<a<4, 0<b<2, 0<c<2, a=2b and b=2−c;
(ii) moieties A and MII are as described herein above; and
(iii) A, MII, a, b and c are selected so as to maintain electroneutrality of the electrode active material in its nascent state.

In one subembodiment, A is Li, 0<a≦3, 0<b≦1.5, and 0<c≦1.5. In another subembodiment, A is Li, 0<a≦2, 0<b≦1, and 0<c≦1. In another subembodiment, A is Li, MII is selected from the group consisting of Ti⁴⁺, Zr⁴⁺, and mixtures thereof, 0<a≦2, 0<b≦1, and 0<c≦1.

In another embodiment, the electrode active material, in its nascent or as-prepared state, is represented by the general formula (IV):

AₐMI_{b-(c/2)}MII_{(c/4)}O₄, (IV)

wherein:
(i) 0<a<8, 0<b<4, and 0<c<2;
(ii) moieties A, MI and MII are as described herein above;
(iii) A, MI, MII, a, b and c are selected so as to maintain electroneutrality of the electrode active material in its nascent state.

In one subembodiment A is Li, 0<a≦4, 0<b≦1.5, and 0<c≦1. In another subembodiment, A is Li, a=2b, 0<a≦3, 0<b≦1.5, and 0<c≦1. In another subembodiment, A is Li, 0<a<6, 0<b≦1, and 0<c≦1. In another subembodiment, A is Li, M is selected from the group consisting of Ti⁴⁺, Zr⁴⁺, and mixtures thereof, 0<a<6, 0<b≦1, and 0<c≦1. In another subembodiment, MI is Ni²⁺.

Non-limiting examples of active materials represented by general formulas (I), (III) and (IV) include the following: LiₐNi_{b}Ti_{c}O₄, LiₐNi_{b}V_{c}O₄, LiₐNi_{b}Zr_{c}O₄, and LiₐNi_{b}Mn_{c}O₄, LiₐFe_{b}Ti_{c}O₄, LiₐCo_{b}V_{c}O₄, LiₐFe_{b}Zr_{c}O₄, and LiₐCo_{b}Mn_{c}O₄.

Methods of making the electrode active materials described by general formulas (I), (III) and (IV) are known by those skilled in the art, and such methods are described are described in: U.S. Patent No. 6,720,112 to Barker et al.; U.S. Pat. No. 6,706,445 to Barker et al.; U.S. Pat. No. 6,103,419 to Saidi et al.; and U.S. Pat. No. 6,482,546 to Ohshita et al.; the teachings of all of which are incorporated herein by reference.

Electrode active materials described by general formulas (I), (III) and (IV) may be synthesized by a solid state reaction of starting materials which provide the alkali metal(s), Ni and elements of moiety M of the active materials. For example, titanium and zirconium are conveniently provided as titanium dioxide and zirconium dioxide starting materials respectively. When M is provided as an oxide starting material, the starting materials can be represented by the formulas M₂O₃, MO₂, and M₂O₅ for an oxidation state of +3, +4, and +5, respectively. It is also possible to provide the metals as hydroxides of general formula M(OH)₃, M(OH)₄ and the like for elements of different oxidation states. A wide variety of materials is suitable as starting material sources of the alkali metal. One preferred lithium starting material is lithium carbonate and sodium carbonate.

The solid state synthesis may be carried out with or without reduction. When the active materials are to be synthesized without reduction, the starting materials are simply combined in a stoichiometric ratio and heated together to form active materials of the desired stoichiometry. When the solid state reaction is carried out in the presence of a reducing agent, it is possible to use starting materials having elements which are initially in a higher oxidation state, and it is possible to incorporate an alkali metal at non-integer levels. During the reaction, the oxidation state of the starting material element is reduced. Either the reducing agent or the alkali metal compound can serve as limiting reagent. However, when the reducing agent is limiting, the electrode active material will contain an unreacted alkali metal compound as an impurity. When the alkali metal-containing compound is limiting, the reducing agent will remain in excess after the reaction. Commonly used reducing agents include elemental carbon and/or hydrogen gas.

In the case of carbon as a reducing agent, the remaining excess carbon does not harm the active material because carbon is itself part of the electrodes made from such active materials. When the reducing agent is hydrogen gas, any excess reducing agent is not incorporated into the starting material because the hydrogen volatilizes and can be removed.

A preferred method of synthesis is a carbothermal reduction where carbon is used as reducing agent, as discussed above. The reducing carbon may be provided as elemental carbon, such as in the form of graphite or carbon black. Alternatively, the reducing carbon may be generated in-situ during the reaction by providing the reducing carbon in the form of a precursor that decomposes or carbonizes to produce carbon during the reaction. Such precursors include, without limitation, cokes, starch, mineral oils, and glycerol and other organic materials, as well as organic polymers that can form carbon material in situ on heating. In a preferred embodiment, the source of reducing carbon undergoes carbonization or decomposition at a temperature below which the other starting materials react.

Thus, the electrode active materials of the present invention can be prepared with a carbothermal preparation method using as starting materials an alkali metal source, a Ni compound or compounds, and one or more M-containing compounds.

Examples of alkali metal sources include without limitation: alkali metal-containing acetates, hydroxides, nitrates, oxalates, oxides, phosphates, dihydrogen phosphates and carbonates, as well as hydrates of the above, as well as mixtures thereof. Examples of sources for Ni and moiety M include oxides, dioxides, trioxides and hydroxides thereof, as well as their elemental form.

In the carbothermal reductive method, the starting materials are mixed together with reducing carbon, which is included in an amount sufficient to reduce the Ni and/or elements comprising moiety M to the desired oxidation state. The carbothermal conditions are set such as to ensure the metal ion does not undergo full reduction to the elemental state. Excess quantities of one or more starting materials other than carbon may be used to enhance product quality. For example, a 5% to 10% excess may be used. The carbon starting material may also be used in excess. When the carbon is used in stoichiometric excess over that required to react as reducant, an amount of carbon, remaining after the reaction, functions as a conductive constituent in the ultimate electrode formulation. This is considered advantageous for the further reason that such remaining carbon will in general be intimately mixed with the product active material. Accordingly, excess carbon is preferred for use in the process, and may be present in a stoichiometric excess amount of 100% or greater.

The carbon present during compound formation is thought to be intimately dispersed throughout the precursor and product. This provides many advantages, including the enhanced conductivity of the product. The presence of carbon particles in the starting materials is also thought to provide nucleation sites for the production of the product crystals.

The starting materials are intimately mixed and then reacted together where the reaction is initiated by heat and is preferably conducted in a non-oxidizing, inert atmosphere. Before reacting the compounds, the particles are mixed or intermingled to form an essentially homogeneous powder mixture of the precursors. In one aspect, the precursor powders are dry-mixed using a ball mill and mixing media, such as zirconia. Then the mixed powders are pressed into pellets. In another aspect, the precursor powders are mixed with a binder. The binder is selected so as to not inhibit reaction between particles of the powders. Therefore, preferred binders decompose or evaporate at a temperature less than the reaction temperature. Examples include, without limitation, mineral oils, glycerol, and polymers that decompose to form a carbon residue before the reaction starts.

In still another aspect, intermingling can be accomplished by forming a wet mixture using a volatile solvent and then the intermingled particles are pressed together in pellet form to provide good grain-to-grain contact.

Although it is desired that the precursor compounds be present in a proportion which provides the stated general formula of the product, the lithium compound may be present in an excess amount on the order of 5 percent excess lithium compared to a stoichiometric mixture of the precursors. As noted earlier, carbon may be present in stoichiometric excess of 100% or greater.

The method of the invention is able to be conducted as an economical carbothermal-based process with a wide variety of precursors and over a relatively broad temperature range. The reaction temperature for reduction depends on the metal-oxide thermodynamics, for example, as described in Ellingham diagrams showing the ΔG (Gibbs Free Energy Change) versus T (temperature) relationship. It is desirable to conduct the reaction at a temperature where the precursor compounds reacts before melting. The various reactions involve production of CO or CO.sub.2 as an effluent gas. The equilibrium at higher temperature favors CO formation. Generally, higher temperature reactions produce CO effluent while lower temperatures result in CO₂ formation from the starting material carbon. At higher temperatures where CO formation is preferred, the stoichiometry requires more carbon be used than the case where CO₂ is produced. The C to CO₂ reaction involves an increase in carbon oxidation state of +4 (from 0 to 4) and the C to CO reaction involves an increase in carbon oxidation state of +2 (from ground state zero to 2). Here, higher temperature generally refers to a range above about 650° C. While there is not believed to be a theoretical upper limit, it is thought that temperatures higher than 1200° C. are not needed. Also, for a given reaction with a given amount of carbon reducant, the higher the temperature the stronger the reducing conditions.

In one aspect, the method of the invention utilizes the reducing capabilities of carbon in a controlled manner to produce desired products having structure and lithium content suitable for electrode active materials. The method of the invention makes it possible to produce products in an economical and convenient process. The advantages are at least in part achieved by the reducant, carbon, having an oxide whose free energy of formation becomes more negative as temperature increases. Such oxide of carbon is more stable at high temperature than at low temperature. This feature is used to produce products having one or more metal ions in a reduced oxidation state relative to the precursor metal ion oxidation state. The method utilizes an effective combination of quantity of carbon, time and temperature to produce new products and to produce known products in a new way.

Referring back to the discussion of temperature, at about 700° C. both the carbon to carbon monoxide and the carbon to carbon dioxide reactions are occurring. At closer to 600° C. the C to CO₂ reaction is the dominant reaction. At closer to 800° C. the C to CO reaction is dominant. Since the reducing effect of the C to CO₂ reaction is greater, the result is that less carbon is needed per atomic unit of metal to be reduced. In the case of carbon to carbon monoxide, each atomic unit of carbon is oxidized from ground state zero to plus 2. Thus, for each atomic unit of metal ion (M) which is being reduced by one oxidation state, one half atomic unit of carbon is required. In the case of the carbon to carbon dioxide reaction, one quarter atomic unit of carbon is stoichiometrically required for each atomic unit of Ni and/or moiety M which is reduced by one oxidation state, because carbon goes from ground state zero to a plus 4 oxidation state. These same relationships apply for each such metal ion being reduced and for each unit reduction in oxidation state desired.

The present invention also provides for batteries containing the novel electrode active material described by general formulas (I), (III) and (IV), wherein the battery includes:
(a) a first electrode (also commonly referred to as a positive electrode or cathode) which includes an active material of the present invention;
(b) a second electrode (also commonly referred to as a negative electrode or anode) which is a counter-electrode to the first electrode; and
(c) an electrolyte in ion-transfer communication with the first and second electrodes.

The electrode active material of this invention may be incorporated into the first electrode, the second electrode, or both. Preferably, the electrode active material is employed in the cathode. The architecture of a battery of the present invention is selected from the group consisting of cylindrical wound designs, wound prismatic and flat-plate prismatic designs, and polymer laminate designs.

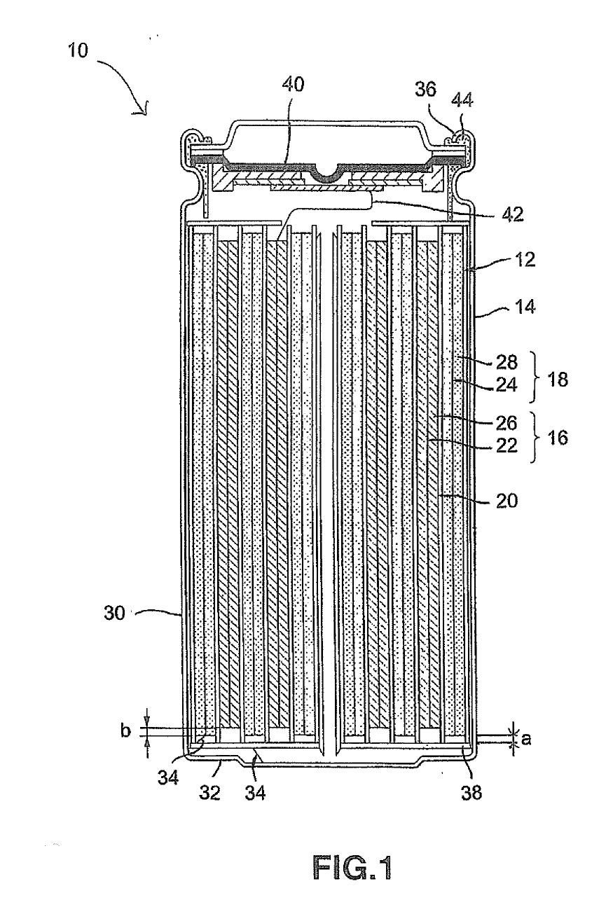

Referring to FIG. 1, in one embodiment, a novel secondary electrochemical cell 10 having an electrode active material of the present invention, includes a spirally coiled or wound electrode assembly 12 enclosed in a sealed container, preferably a rigid cylindrical casing 14 as illustrated in FIG. 1. In one subembodiment, the cell 10 is a prismatic-type cell, and the casing has a substantially rectangular cross-section (not illustrated).

Referring again to FIG. 1, the electrode assembly 12 includes: a positive electrode 16 consisting of, among other things, an electrode active material represented by general formulas (I), (III) and (IV); a counter negative electrode 18; and a separator 20 interposed between the first and second electrodes 16,18. The separator 20 is preferably an electrically insulating, ionically conductive microporous film, and composed of a polymeric material selected from the group consisting of polyethylene, polyethylene oxide, polyacrylonitrile and polyvinylidene fluoride, polymethyl methacrylate, polysiloxane, copolymers thereof, and admixtures thereof.

Each electrode 16,18 includes a current collector 22 and 24, respectively, for providing electrical communication between the electrodes 16,18 and an external load. Each current collector 22,24 is a foil or grid of an electrically conductive metal such as iron, copper, aluminum, titanium, nickel, stainless steel, or the like, having a thickness of between 5 μm and 100 μm, preferably 5 μm and 20 μm. Optionally, the current collector may be treated with an oxide-removing agent such as a mild acid and the like, and coated with an electrically conductive coating for inhibiting the formation of electrically insulating oxides on the surface of the current collector 22,24. Examples of a suitable coatings include polymeric materials comprising a homogenously dispersed electrically conductive material (e.g. carbon), such polymeric materials including: acrylics including acrylic acid and methacrylic acids and esters, including poly(ethylene-co-acrylic acid); vinylic materials including poly(vinyl acetate) and poly(vinylidene fluoride-co-hexafluoropropylene); polyesters including poly(adipic acid-co-ethylene glycol); polyurethanes; fluoroelastomers; and mixtures thereof.

The positive electrode 16 further includes a positive electrode film 26 formed on at least one side of the positive electrode current collector 22, preferably both sides of the positive electrode current collector 22, each film 26 having a thickness of between 10 μm and 150 μm, preferably between 25 μm an 125 μm, in order to realize the optimal capacity for the cell 10. The positive electrode film 26 is composed of between 80% and 95% by weight of an electrode active material represented by the general formulas (I), (III) and (IV), between 1% and 10% by weight binder, and between 1% and 10% by weight electrically conductive agent.

Suitable binders include: polyacrylic acid; carboxymethylcellulose; diacetylcellulose; hydroxypropylcellulose; polyethylene; polypropylene; ethylene-propylene-diene copolymer; polytetrafluoroethylene; polyvinylidene fluoride; styrene-butadiene rubber; tetrafluoroethylene-hexafluoropropylene copolymer; polyvinyl alcohol; polyvinyl chloride; polyvinyl pyrrolidone; tetrafluoroethylene-perfluoroalkylvinyl ether copolymer; vinylidene fluoride-hexafluoropropylene copolymer; vinylidene fluoride-chlorotrifluoroethylene copolymer; ethylenetetrafluoroethylene copolymer; polychlorotrifluoroethylene; vinylidene fluoride-pentafluoropropylene copolymer; propylene-tetrafluoroethylene copolymer; ethylene-chlorotrifluoroethylene copolymer; vinylidene fluoride-hexafluoropropylene-tetrafluoroethylene copolymer; vinylidene fluoride-perfluoromethylvinyl ether-tetrafluoroethylene copolymer; ethylene-acrylic acid copolymer; ethylene-methacrylic acid copolymer; ethylene-methyl acrylate copolymer; ethylene-methyl methacrylate copolymer; styrene-butadiene rubber; fluorinated rubber; polybutadiene, and admixtures thereof. Of these materials, most preferred are polyvinylidene fluoride and polytetrafluoroethylene.

Suitable electrically conductive agents include: natural graphite (e.g. flaky graphite, and the like); manufactured graphite; carbon blacks such as acetylene black, Ketzen black, channel black, furnace black, lamp black, thermal black, and the like; conductive fibers such as carbon fibers and metallic fibers; metal powders such as carbon fluoride, copper, nickel, and the like; and organic conductive materials such as polyphenylene derivatives.

The negative electrode 18 is formed of a negative electrode film 28 formed on at least one side of the negative electrode current collector 24, preferably both sides of the negative electrode current collector 24. The negative electrode film 28 is composed of between 80% and 95% of an intercalation material, between 2% and 10% by weight binder, and (optionally) between 1% and 10% by of an weight electrically conductive agent.

Intercalation materials suitable herein include: transition metal oxides, metal chalcogenides, carbons (e.g. graphite), and mixtures thereof. In one embodiment, the intercalation material is selected from the group consisting of crystalline graphite and amorphous graphite, and mixtures thereof, each such graphite having one or more of the following properties: a lattice interplane (002) d-value (d₍₀₀₂₎) obtained by X-ray diffraction of between 3.35 Å to 3.34 Å, inclusive (3.35 Å≦d₍₀₀₂₎≦3.34 Å), preferably 3.354 Å to 3.370 Å, inclusive (3.354 Å≦d₍₀₀₂₎≦3.370 Å; a crystallite size (L_{c}) in the c-axis direction obtained by X-ray diffraction of at least 200 Å, inclusive (L_{c}≧200 Å), preferably between 200 Å and 1,000 Å, inclusive (200 Å≦L_{c}≦1,000 Å); an average particle diameter (P_{d}) of between 1 μm to 30 μm, inclusive (1 μm≦P_{d}≦30 μm); a specific surface (SA) area of between 0.5 m²/g to 50 m²/g, inclusive (0.5 m²/g≦SA≦50 m²/g); and a true density (ρ) of between 1.9 g/cm³ to 2.25 g/cm³, inclusive (1.9 g/cm³≦ρ≦2.25 g/cm³).

Referring again to FIG. 1, to ensure that the electrodes 16,18 do not come into electrical contact with one another, in the event the electrodes 16,18 become offset during the winding operation during manufacture, the separator 20 “overhangs” or extends a width “a” beyond each edge of the negative electrode 18. In one embodiment, 50 μm≦a≦2,000 μm. To ensure alkali metal does not plate on the edges of the negative electrode 18 during charging, the negative electrode 18 “overhangs” or extends a width “b” beyond each edge of the positive electrode 16. In one embodiment, 50 μm≦b≦2,000 μm.

The cylindrical casing 14 includes a cylindrical body member 30 having a closed end 32 in electrical communication with the negative electrode 18 via a negative electrode lead 34, and an open end defined by crimped edge 36. In operation, the cylindrical body member 30, and more particularly the closed end 32, is electrically conductive and provides electrical communication between the negative electrode 18 and an external load (not illustrated). An insulating member 38 is interposed between the spirally coiled or wound electrode assembly 12 and the closed end 32.

A positive terminal subassembly 40 in electrical communication with the positive electrode 16 via a positive electrode lead 42 provides electrical communication between the positive electrode 16 and the external load (not illustrated). Preferably, the positive terminal subassembly 40 is adapted to sever electrical communication between the positive electrode 16 and an external load/charging device in the event of an overcharge condition (e.g. by way of positive temperature coefficient (PTC) element), elevated temperature and/or in the event of excess gas generation within the cylindrical casing 14. Suitable positive terminal assemblies 40 are disclosed in U.S. Pat. No. 6,632,572 to Iwaizono, et al., issued Oct. 14, 2003; and U.S. Pat. No. 6,667,132 to Okochi, et al., issued Dec. 23, 2003. A gasket member 44 sealingly engages the upper portion of the cylindrical body member 30 to the positive terminal subassembly 40.

A non-aqueous electrolyte (not shown) is provided for transferring ionic charge carriers between the positive electrode 16 and the negative electrode 18 during charge and discharge of the electrochemical cell 10. The electrolyte includes a non-aqueous solvent and an alkali metal salt dissolved therein. Suitable solvents include: a cyclic carbonate such as ethylene carbonate, propylene carbonate, butylene carbonate or vinylene carbonate; a non-cyclic carbonate such as dimethyl carbonate, diethyl carbonate, ethyl methyl carbonate or dipropyl carbonate; an aliphatic carboxylic acid ester such as methyl formate, methyl acetate, methyl propionate or ethyl propionate; a .gamma.-lactone such as y-butyrolactone; a non-cyclic ether such as 1,2-dimethoxyethane, 1,2-diethoxyethane or ethoxymethoxyethane; a cyclic ether such as tetrahydrofuran or 2-methyltetrahydrofuran; an organic aprotic solvent such as dimethylsulfoxide, 1,3-dioxolane, formamide, acetamide, dimethylformamide, dioxolane, acetonitrile, propylnitrile, nitromethane, ethyl monoglyme, phospheric acid triester, trimethoxymethane, a dioxolane derivative, sulfolane, methylsulfolane, 1,3-dimethyl-2-imidazolidinone, 3-methyl-2-oxazolidinone a propylene carbonate derivative, a tetrahydrofuran derivative, ethyl ether, 1,3-propanesultone, anisole, dimethylsulfoxide and N-methylpyrrolidone; and mixtures thereof. A mixture of a cyclic carbonate and a non-cyclic carbonate or a mixture of a cyclic carbonate, a non-cyclic carbonate and an aliphatic carboxylip acid ester, are preferred.

Suitable alkali metal salts include: LiCIO₄; LiBF₄; LiPF₆; LiAlCl₄; LiSbF₆; LiSCN; LiCl; LiCF₃ SO₃; LiCF₃CO₂; Li(CF₃SO₂)₂; LiAsF₆; LiN(CF₃SO2)₂; LiB₁₀Cl₁₀; a lithium lower aliphatic carboxylate; LiCl; LiBr; LiI; a chloroboran of lithium; lithium tetraphenylborate; lithium imides; sodium and potassium analogues of the aforementioned lithium salts; and mixtures thereof. Preferably, the electrolyte contains at least LiPF₆.

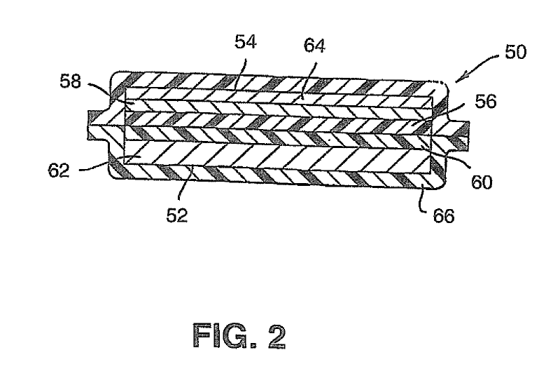

Referring to FIG. 2, in another embodiment, a polymer laminate-type secondary electrochemical cell 50 having an electrode active material represented by the general formulas (I), (III) and (IV), includes a laminated or polymer stacked cell structure, having a negative electrode 52, a positive electrode 54, and an electrolyte/separator 56 there between. The negative electrode 52 includes a current collector 60 (preferably, a copper foil or grid) in electrical communication with a negative electrode membrane or film 62; and the positive electrode 54 includes a current collector 58 (preferably, an aluminum foil or grid) in electrical communication with a positive electrode membrane or film 64. Protective bagging material 66 covers the cell and prevents infiltration of air and moisture. Such structures are disclosed in, for example, U.S. Pat. No. 4,925,752 to Fauteux et al; U.S. Pat. No. 5,011,501 to Shackle et al.; and U.S. Pat. No. 5,326,653 to Chang; all of which are incorporated by reference herein.

The relative weight proportions of the components of the positive electrode 54 are generally: about 50-90% by weight active material represented by general formulas (I), (III) and (IV); 5-30% carbon black as the electric conductive diluent; and 3-20% binder chosen to hold all particulate materials in contact with one another without degrading ionic conductivity. Stated ranges are not critical, and the amount of active material in an electrode may range from 25-95 weight percent. The negative electrode 52 includes about 50-95% by weight of a preferred intercalation material, with the balance constituted by the binder. In a preferred embodiment, the negative electrode intercalation material is graphite. For test purposes, test cells are often fabricated using lithium metal electrodes.

Those skilled in the art will understand that any number of methods are used to form films from the casting solution using conventional meter bar or doctor blade apparatus. It is usually sufficient to air-dry the films at moderate temperature to yield self-supporting films of copolymer composition. Lamination of assembled cell structures is accomplished by conventional means by pressing between metal plates at a temperature of about 120-160° C. Subsequent to lamination, the battery cell material may be stored either with the retained plasticizer or as a dry sheet after extraction of the plasticizer with a selective low-boiling point solvent. The plasticizer extraction solvent is not critical, and methanol or ether are often used.

Separator membrane element 16 is generally polymeric and prepared from a composition comprising a copolymer. A preferred composition is the 75 to 92% vinylidene fluoride with 8 to 25% hexafluoropropylene copolymer (available commercially from Atochem North America as Kynar FLEX) and an organic solvent plasticizer. Such a copolymer composition is also preferred for the preparation of the electrode membrane elements, since subsequent laminate interface compatibility is ensured. The plasticizing solvent may be one of the various organic compounds commonly used as solvents for electrolyte salts, e.g., propylene carbonate or ethylene carbonate, as well as mixtures of these compounds. Higher-boiling plasticizer compounds such as dibutyl phthalate, dimethyl phthalate, diethyl phthalate, and tris butoxyethyl phosphate are particularly suitable. Inorganic filler adjuncts, such as fumed alumina or silanized fumed silica, may be used to enhance the physical strength and melt viscosity of a separator membrane and, in some compositions, to increase the subsequent level of electrolyte solution absorption.

Electrolyte solvents are selected to be used individually or in mixtures, and include dimethyl carbonate (DMC), diethylcarbonate (DEC), dipropylcarbonate (DPC), ethylmethylcarbonate (EMC), ethylene carbonate (EC), propylene carbonate (PC), butylene carbonate, lactones, esters, glymes, sulfoxides, sulfolanes, and mixtures thereof. The preferred solvents are EC/DMC, EC/DEC, EC/DPC and EC/EMC. The salt content ranges from 5% to 65% by weight, preferably from 8% to 35% by weight. One example is a mixture of EC:DMC:LiPF₆ in a weight ratio of about 60:30:10. Desirable solvents and salts are described in U.S. Pat. No. 5,643,695 to Barker et al. and U.S. Pat. No. 5,418,091 to Gozdz et al.

Examples of forming laminate and polymer stacked cells are disclosed in U.S. Pat. No. 4,668,595 to Yoshino et al.; U.S. Pat. No. 4,830,939 to Lee et al.; U.S. Pat. No. 4,935,317 to Fauteux et al.; U.S. Pat. No. 4,990,413 to Lee et al.; U.S. Pat. No. 4,792,504 to Schwab et al.; U.S. Pat. No. 5,037,712 to Shackle et al.; U.S. Pat. No. 5,262,253 to Golovin; U.S. Pat. No. 5,300,373 to Shackle; U.S. Pat. No. 5,435,054 to Tonder et al.; U.S. Pat. No. 5,463,179 to Chalonger-Gill et al.; U.S. Pat. No. 5,399,447 to Chalonger-Gill et al.; U.S. Pat. No. 5,482,795 to Chalonger-Gill and U.S. Pat. No. 5,411,820 to Chalonger-Gill; each of which is incorporated herein by reference in its entirety. Note that the older generation of cells contained organic polymeric and inorganic electrolyte matrix materials, with the polymeric being most preferred. The polyethylene oxide of 5,411,820 is an example. More modern examples are the VdF:HFP polymeric matrix. Examples of casting, lamination and formation of cells using VdF:HFP are as described in U.S. Pat. No. 5,418,091 to Gozdz; U.S. Pat. No. 5,460,904 to Gozdz; U.S. Pat. No. 5,456,000 to Gozdz et al.; and U.S. Pat. No. 5,540,741 to Gozdz et al.; each of which is incorporated herein by reference in its entirety.

The following non-limiting examples illustrate the compositions and methods of the present invention.

### EXAMPLE 1

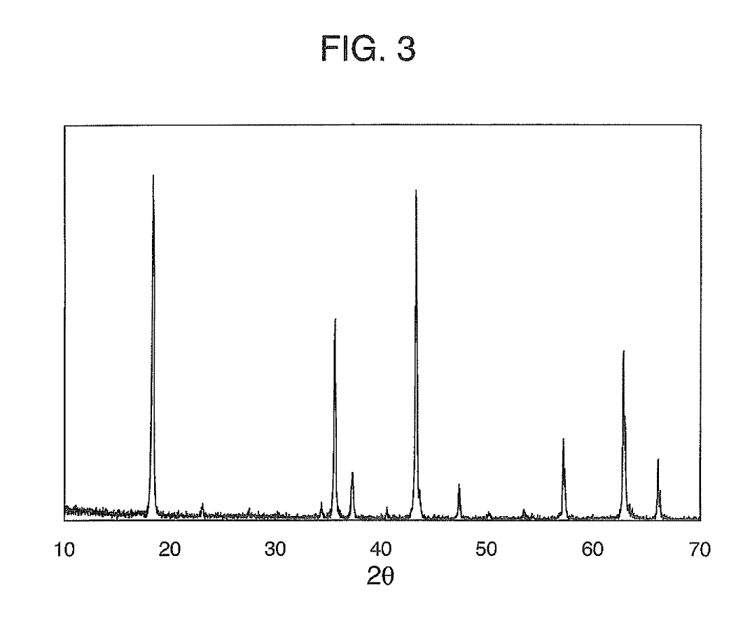

An electrode active material comprising LiNi_{0.5}Ti_{1.5}O₄ is made as follows. A mixture of 5 g of TiO₂ (Aldrich, 99.9%), 1.9654 g of LiOH.H₂O (Aldrich, 98%), and 2.4523 g of 2NiCO₃.3Ni(OH)₃.4H₂O (Aldrich) is made, using a mortar and pestle. The mixture is pelletized, and transferred to a tube furnace equipped with an argon gas flow. The mixture is heated to a temperature of 700° C. to 800° C., and maintained at this temperature for 12-24 hours. An X-ray powder diffraction analysis for LiNi_{0.5}Ti_{1.50}O₄ fired at 800° C. for 15 hrs, is illustrated in FIG. 3. The X-ray powder diffraction analysis for the LiNi_{0.5}Ti_{1.5}O₄ material indicated the material to be of the space group Fd3m (a 8.37 Å).

An electrochemical test cell is constructed as follows. An electrode is made with 80% of the active material, 10% of Super P conductive carbon, and 10% 11-wt % PVdF-HFP co-polymer (Elf Atochem) binder. The size of the electrode is 2.85 cm². The electrolyte comprises a 1M LiPF₆ solution in ethylene carbonate/dimethyl carbonate (2:1 by weight), while a dried glass fiber filter (Whatman, Grade GF/A) is used as an electrode separator.

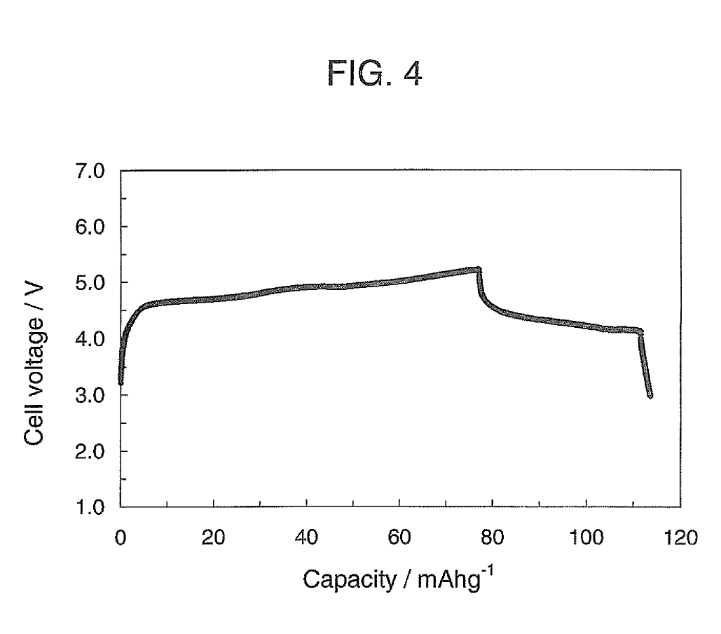

An electrochemical cell constructed per this Example, comprising LiNi_{0.5}Ti_{1.5}O₄ fired at 700° C. for 24 hours, was charged to 5.2V and then discharged to 3V at a current of 50 μA at a rate of 18 μA/cm² or C/100. FIG. 4 is a plot of cathode specific capacity vs. cell voltage for the cell. As FIG. 4 indicates, the cell exhibited a 77 mA/g charge capacity.

### EXAMPLE 2

An electrode active material comprising Li₃Ni_{1.5}Zr_{0.5}O₄ is made as follows. A mixture of 2 g of ZrO₂ (Aldrich, 99.9%), 4.1656 g of LiOH.H₂O (Aldrich, 98%), and 5.7168 g of 2NiCO₃.3Ni(OH)₃.4H₂O (Aldrich) is made, using a mortar and pestle. The mixture is pelletized, and transferred to a tube furnace equipped with an argon gas flow. The mixture is heated to a temperature of 700° C. to 800° C., and maintained at this temperature for 12-24 hours.

An electrochemical test cell is constructed as follows. An electrode is made with 80% of the active material, 10% of Super P conductive carbon, and 10% 11-wt % PVdF-HFP co-polymer (Elf Atochem) binder. The size of the electrode is 2.8 cm². The electrolyte comprises a 1M LiPF₆ solution in ethylene carbonate/dimethyl carbonate (2:1 by weight), while a dried glass fiber filter (Whatman, Grade GF/A) is used as an electrode separator.

### EXAMPLE 3

An electrode active material comprising Li₂NiVO₄ is made as follows. A mixture of 5 g of V₂O₃ (Aldrich), 2.8539 g of LiOH.H₂O (Aldrich, 98%), and 3.9166 g of 2NiCO₃.3Ni(OH)₃.4H₂O (Aldrich) is made, using a mortar and pestle. The mixture is pelletized, and transferred to a tube furnace equipped with an argon gas flow. The mixture is heated to a temperature of 700° C. to 800° C., and maintained at this temperature for 12-24 hours.

An electrochemical test cell is constructed as follows. An electrode is made with 80% of the active material, 10% of Super P conductive carbon, and 10% 11-wt % PVdF-HFP co-polymer (Elf Atochem) binder. The size of the electrode is 2.85 cm². The electrolyte comprises a 1M LiPF₆ solution in ethylene carbonate/dimethyl carbonate (2:1 by weight), while a dried glass fiber filter (Whatman, Grade GF/A) is used as an electrode separator.

The examples and other embodiments described herein are exemplary and not intended to be limiting in describing the full scope of compositions and methods of this invention. Equivalent changes, modifications and variations of specific embodiments, materials, compositions and methods may be made within the scope of the present invention, with substantially similar results.

What is claimed is:

1. A battery, comprising:
a positive electrode comprising an electrode active material represented by the general formula:
AₐMI_{b}MII_{c}O₄,
wherein:
(i) A is selected from the group consisting of elements from Group I of the Periodic Table, and mixtures thereof, wherein 0<a<8;
(ii) MI is selected from the group consisting of divalent cations, and mixtures thereof, wherein 0<b<4; and
(iii) MII is selected from the group consisting of tetravalent cations, and mixtures thereof, wherein 0<c<2;
(iv) wherein at least one of the cations comprising MI and MII is redox active; and
(v) wherein A, MI, MII, a, b and c are selected so as to maintain electroneutrality of the electrode active material in its nascent state;
the battery further comprising a negative electrode; and
an electrolyte.

2. The battery of claim 1, wherein the intercalation active material is selected from the group consisting of a transition metal oxide, a metal chalcogenide, graphite, and mixtures thereof.

3. The battery of claim 2, wherein the intercalation active material is a graphite having a lattice interplane (002) d-value (d₍₀₀₂₎) obtained by X-ray diffraction of 3.35 Å to 3.34 Å

4. The battery of claim 3, wherein the graphite has a lattice interplane (002) d-value (d₍₀₀₂₎) obtained by X-ray diffraction of 3.354 Å to 3.370 Å.

5. The battery of claim 3, wherein the graphite further has a crystallite size (L_{c}) in the c-axis direction obtained by X-ray diffraction of at least 200 Å,

6. The battery of claim 5, wherein the graphite has a crystallite size (L_{c}) in the c-axis direction obtained by X-ray diffraction of between 200 Å and 1,000 Å.

7. The battery of claim 5, wherein the graphite further has an average particle diameter of 1 μm to 30 μm.

8. The battery of claim 7, wherein the graphite further has a specific surface area of 0.5 m²/g to 50 m²/g; and a true density of 1.9 g/cm³ to 2.25 g/cm³.

9. The battery of claim 2, wherein the positive electrode comprising a positive electrode film coated on each side of a positive electrode current collector, each positive electrode film having a thickness of between 10 μm and 150 μm, the positive electrode current collector having a thickness of between 5 μm and 100 μm.

10. The battery of claim 9, wherein each positive electrode film further comprises a binder.

11. The battery of claim 10, wherein the binder is polyvinylidene fluoride.

12. The battery of claim 11, wherein the positive electrode film further comprises an electrically conductive agent.

13. The battery of claim 2, wherein the positive electrode comprising a positive electrode film coated on each side of a positive electrode current collector, each positive electrode film having a thickness of between 10 μm and 150 μm, the positive electrode current collector having a thickness of between 5 μm and 100 μm.

14. The battery of claim 1, wherein MI is selected from the group consisting of is selected from the group consisting of Fe²⁺, Co²⁺, Ni²⁺ and mixtures thereof.

15. The battery of claim 14, wherein MII is selected from the group consisting of Ti⁴⁺, V⁴⁺, Mn⁴⁺, Zr⁴⁺, Ru⁴⁺, Pd⁴⁺, Sn⁴⁺, Mo⁴⁺, Pt⁴⁺, Si⁴⁺, C⁴⁺, and mixtures thereof.

16. The battery of claim 1, wherein the electrode active material is represented by the general formula:
AₐNi_{b}MII_{c}O₄,
wherein 0<a<4, 0<b<2, 0<c<2, a=2b and b=2−c.

17. The battery of claim 16, wherein A is Li, 0<a≦3, 0<b≦1.5, and 0<c≦1.5. In another subembodiment, A is Li, 0<a≦2, 0<b≦1, and 0<c≦1.

18. The battery of claim 16, wherein A is Li, M is selected from the group consisting of Ti⁴⁺, Zr⁴⁺, and mixtures thereof, 0<a≦2, 0<b≦1, and 0<c≦1.

19. The battery of claim 1, wherein the electrode active material is represented by the general formula:
AₐNi_{b-(c/2)}MII_{(c/4)}O₄,
wherein 0<a<8, 0<b<4, and 0<c<2.

20. The battery of claim 19, wherein A is Li, 0<a≦4, 0<b≦1.5, and 0<c≦1.

21. The battery of claim 19, wherein A is Li, a=2b, 0<a≦3, 0<b≦1.5, and 0<c≦1.

22. The battery of claim 19, wherein A is Li, M is selected from the group consisting of Ti⁴⁺, Zr⁴⁺, and mixtures thereof, 0<a<6, 0<b≦1, and 0<c≦1.
